(19) United States
(12) Patent Application Publication
(10) Pub. No.: US 2005/0264196 A1
(43) Pub. Date: Dec. 1, 2005

(54) Plasma display panel apparatus

(75) Inventor: Jun Kamiyamaguchi, Yamanashi-ken (JP)

Correspondence Address: ARENT FOX PLLC, 1050 CONNECTICUT AVENUE, N.W., SUITE 400, WASHINGTON, DC, 20036, US

(73) Assignee: Pioneer Corporation

(21) Appl. No.: 11/130,155

(22) Filed: May 17, 2005

(30) Foreign Application Priority Data
May 26, 2004 (JP) JP2004-156019

(51) Int. Cl. H01J 17/49

(52) U.S. Cl. 313/582

(57) ABSTRACT

Discharge cells are arranged in matrix form in the discharge space defined between a front glass substrate and a back glass substrate. Red, green and blue phosphor layers are formed individually in the discharge cells such that the phosphor layers formed in adjacent discharge cells in the column direction have different colors. One pixel consists of three adjacent discharge cells arranged in the row direction and respectively having the red phosphor layer, the green phosphor layer and the blue phosphor layer formed therein. The pixels are arranged in matrix form in the row direction and the column direction.

### BACKGROUND OF THE INVENTION

1. Field of the Invention

This invention relates to surface-discharge-type alternating-current plasma display panel apparatuses.

The present application claims priority from Japanese Application No. 2004-156019, the disclosure of which is incorporated herein by reference.

2. Description of the Related Art

FIG. 1 is a perspective view showing the structure of a conventional surface-discharge-type alternating-current plasma display panel (hereinafter referred to as “PDP”).

The PDP as shown in FIG. 1 often has a plurality of row electrode pairs (X, Y) extending in the row direction and regularly arranged in the column direction on a rear-facing face (i.e. the face facing toward the rear of the PDP) of a front glass substrate 1 serving as the display face of the PDP.

The row electrodes X and Y constituting each of the row electrode pairs (X, Y) are respectively composed of transparent electrodes Xa, Ya extending in a bar shape in the row direction, and bus electrodes Xb, Yb connected to the transparent electrodes Xa, Ya. The opposing transparent electrodes Xa and Ya have discharge portions Xa1, Ya1 formed integrally in positions regularly spaced along the confronting sides of the transparent electrodes. The discharge portions Xa1 and Ya1 extend out from the associated transparent electrodes toward their counterparts to face each other across a discharge gap g.

A dielectric layer 2 is formed on the rear-facing face of the front glass substrate 1 so as to cover the row electrode pairs (X, Y), and has an MgO protective layers 3 formed on the rear-facing face of the dielectric layer 2.

The front glass substrate 1 is parallel to a back glass substrate 4 with a discharge space S in between. A plurality of column electrodes D extends in the column direction and is regularly arranged in the row direction on the front-facing face (i.e. the face facing toward the front of the PDP) of the back glass substrate 4. Each of the column electrodes D is formed in a position confronting the discharge portions Xa1 and Ya1 of the row electrodes X and Y formed on the front glass substrate 1. Further, a plurality of partition walls 5 extends in the column direction, each lying in an intermediate position between the adjacent column electrodes D. The partition walls 5 are arranged regularly in the row direction.

Red-, green-, and blue-colored phosphor layers 6R, 6G and 6B are formed on the portions of the face of the back glass substrate 4 lying between the partition walls 5 and on the side faces of the partition walls 5 so as to be arranged in order in the row direction.

The discharge space is filled with a discharge gas including xenon (Xe).

The PDP has discharge cells formed in the discharge space in positions each corresponding to the confronting discharge portion Xa1 and Ya1 of the row electrodes X and Y across the discharge gap g.

A conventional PDP of such a structure is disclosed in Japanese Patent Laid-open publication 11-242933, for example.

As shown in FIG. 2, in the conventional PDP as described hitherto, each of the phosphor layers 6R, 6G and 6B extends in the column direction (the vertical direction in FIG. 2) in an area lying between adjacent partition walls 5. Therefore, the discharge cells C having the phosphor layers of the same color are arranged in the column direction.

The three discharge cells C adjoining in the row direction, namely, the three discharge cells of the three primary colors, red, green and blue, provided by the phosphor layers 6R, 6G and 6B arranged in the row direction, form a pixel G.

In this connection, the human eye usually has the property of a high sensitivity in the vertical direction and the horizontal direction but a low sensitivity in an oblique direction.

For example, when a raster signal is input to the PDP for displaying a single color from among the red, green and blue colors, the light emission produced from the discharge cells C having the phosphor layers 6R, 6G or 6B is only of the color to be displayed (for example, the green discharge cells C). The remaining discharge cells C with the phosphor layers of the remaining colors (for example, the red and blue discharge cells C) do not emit light. Thus, black bar-shaped lines are created in the area in which the discharge cells emitting no light are arranged in the column direction.

As a result, a conventional PDP has the problem of a low spatial frequency for the human eye, in other words, it gives the feeling that the picture quality of the image being displayed is rough.

### SUMMARY OF THE INVENTION

An object of the present invention is to solve the problem associated with the surface-discharge-type alternating-current PDPs as described above.

To attain this object, a plasma display panel apparatus according to the present invention has unit light-emitting areas arranged in matrix form in the row direction and the column direction in a discharge space formed between a pair of parallel opposing substrates, and phosphor layers of three primary colors, red, green and blue, formed individually in the unit light-emitting areas, in which the unit light-emitting area having the red phosphor layer formed therein, the unit light-emitting area having the green phosphor layer formed therein and the unit light-emitting area having the blue phosphor layer formed therein form a pixel. In this PDP, the adjacent unit light-emitting areas in the column direction are assigned the phosphor layers of different colors, and each of the pixels consists of the three adjacent unit light-emitting areas arranged in the row direction and respectively having the red phosphor layer, the green phosphor layer and the blue phosphor layer formed thereon, and the pixels are arranged in matrix form in the row direction and the column direction.

An embodiment of the present invention can be described by citing a PDP having the following structure. A discharge space is formed between a front glass substrate having row electrode pairs formed thereon and a back glass substrate having column electrode formed thereon. The discharge space is partitioned by a partition wall unit of an approximate grid shape made up of vertical walls and the transverse walls to form discharge cells arranged in matrix form. Phosphor layers to which the three primary colors, red, green and blue, are applied individually are provided in the respective discharge cells such that the phosphor layers of different colors are provided in adjacent discharge cells in the column direction. The three adjacent discharge cells in the row direction respectively having the red phosphor layer, the green phosphor layer and the blue phosphor layer formed thereon form a single pixel. The pixels are arranged in matrix form in the row direction and the column direction.

In the PDP according to the embodiment, the red, green and blue phosphor layers are formed in the discharge cells arranged in matrix form in the row direction and the column direction. The phosphor layers of the same colors are not provided in the discharge cells adjacent to each other in the column direction. In the case when an image is displayed using a single-color raster signal, for example, a conventional PDP emits light of the same color in a stripe pattern extending in the column direction. However, due to this arrangement, in the PDP according to the present invention, light of the same color is emitted from different points in adjacent display lines in the column direction.

At such times, the discharge cells not emitting light lie in the oblique direction. However, the visual sensitivity of the human eye is lower in the oblique direction as compared with the visual sensitivities in the vertical direction and the horizontal direction. Therefore, the obtrusive presence of the discharge cells not emitting light is made inconspicuous as compared with the case where the light emission is not produced from the discharge cells arranged in the vertical direction. As a result, the PDP apparatus according to the embodiment is capable of displaying an image having a high spatial frequency enabling the viewers to perceive a picture with high definition.

These and other objects and features of the present invention will become more apparent from the following detailed description with reference to the accompanying drawings.

### BRIEF DESCRIPTION OF THE DRAWINGS

FIG. 1 is a perspective view illustrating an example of the related art.

FIG. 2 is a front view illustrating a conventional arrangement of phosphor layers.

FIG. 3 is a perspective view illustrating a first embodiment according to the present invention.

FIG. 4 is a front view illustrating an arrangement of phosphor layers and pixel layout in the first embodiment.

FIG. 5 is a block diagram illustrating the structure of a drive unit in the first embodiment.

FIG. 6A is an explanatory diagram illustrating a switching mode for an address data signal in the first embodiment.

FIG. 6B is an explanatory diagram illustrating another switching mode for an address data signal in the first embodiment.

FIG. 6C is an explanatory diagram illustrating yet another switching mode for an address data signal in the first embodiment.

FIG. 7 is a sectional view illustrating a second embodiment in the present invention.

FIG. 8 is a front view showing the shape of an R column electrode in the second embodiment.

FIG. 9 is a front view showing the shape of a G column electrode in the second embodiment.

FIG. 10 is a front view showing the shape of a B column electrode in the second embodiment.

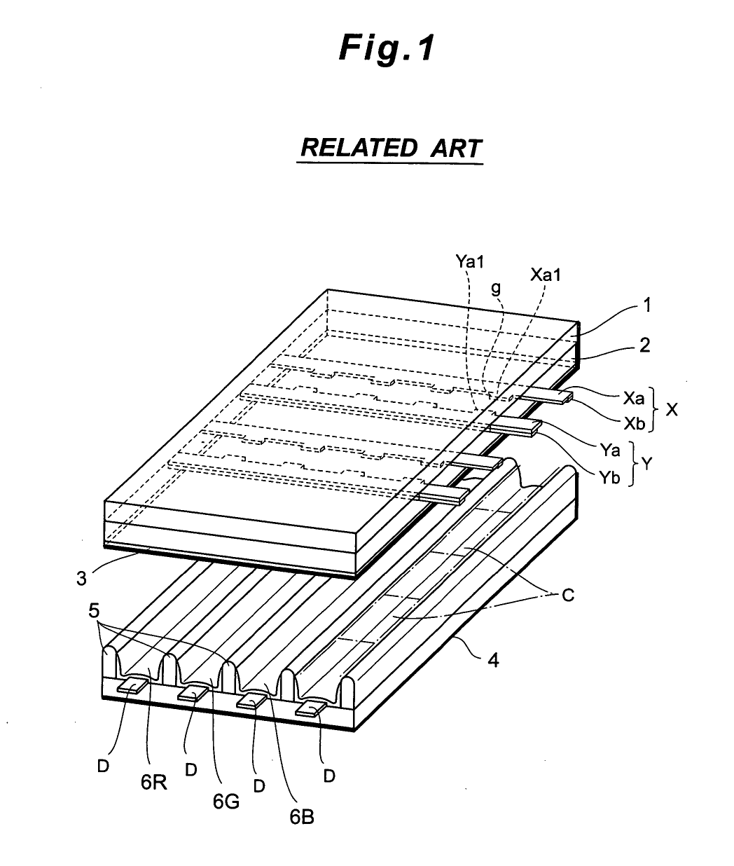

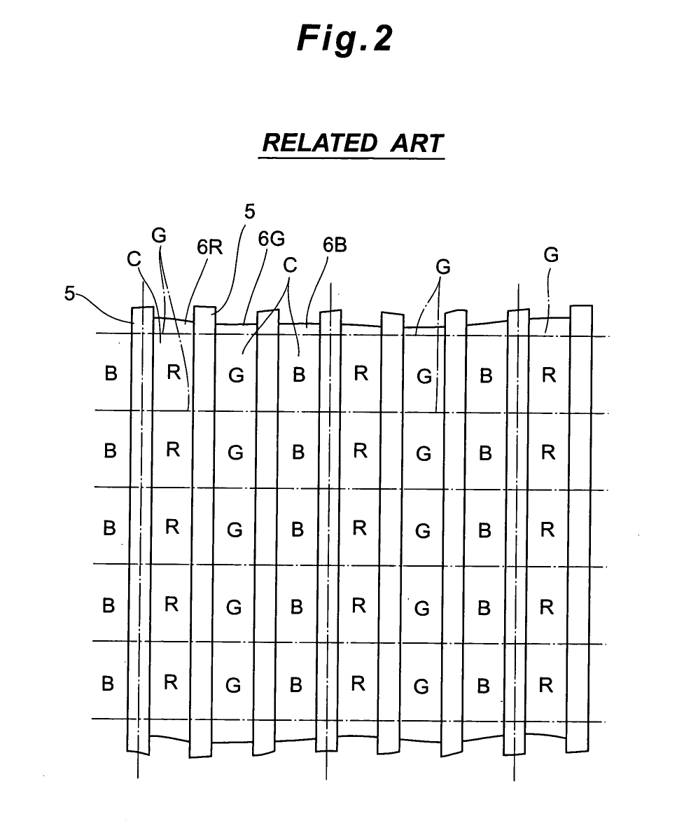

### DETAILED DESCRIPTION OF THE PREFERRED EMBODIMENTS

### First Embodiment

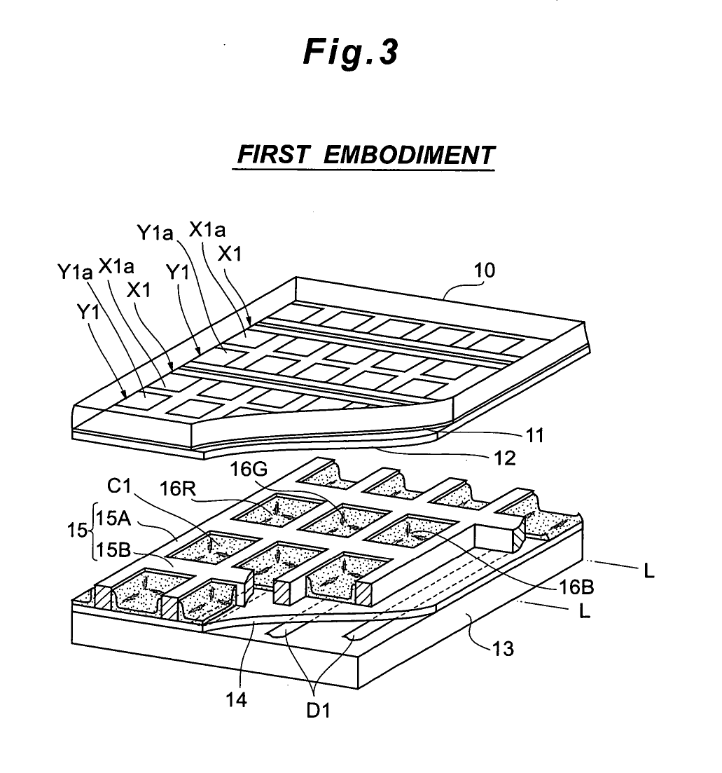

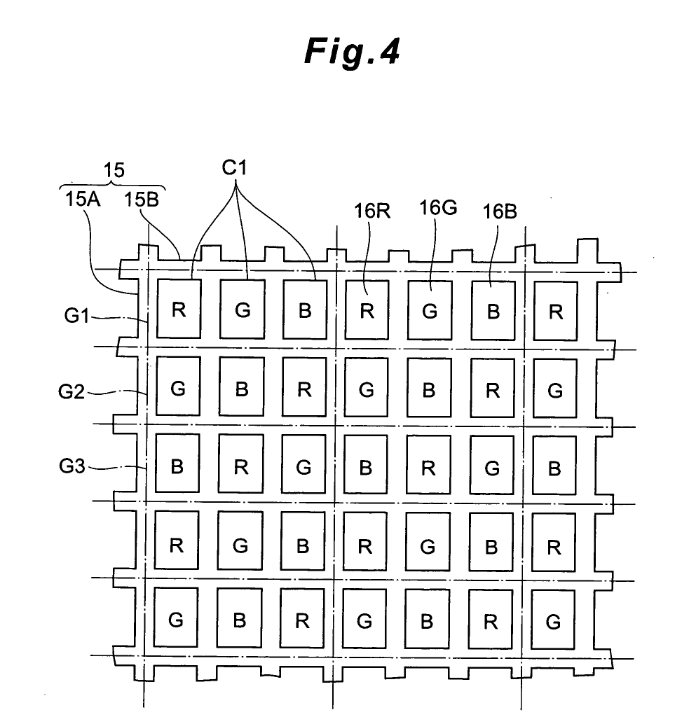

FIGS. 3 and 4 illustrate a first embodiment of a PDP according to the present invention. FIG. 3 is a perspective view of the structure of the PDP when a front glass substrate and a back glass substrate are separated from each other. FIG. 4 is a front view showing the color arrangement of the phosphor layer formed in the respective discharge cells of the PDP.

In FIG. 3, in the PDP, row electrode pairs (X1, Y1) and a dielectric layer 11 and a protective layer 12 covering the row electrode pairs (X1, Y1) are formed on the rear-facing face of the front glass substrate 10. Column electrodes D1 and a column-electrode protective layer 14 covering the column electrodes D1 are formed on the back glass substrate 13. A partition wall unit 15 is formed, on the column-electrode protective layer 14, in an approximate grid shape made up of the vertical walls 15A extending in the column direction and transverse walls 15B extending in the row direction. The partition wall unit 15 partitions the discharge space defined between the front glass substrate 10 and the back glass substrate 13 into discharge cells C1.

Red (R)-, green (G)- and blue (B)-colored phosphor layers 16R, 16G and 16B each cover the face of the column-electrode protective layer 14 and the sides of the two vertical walls 15A and the two transverse walls 15B in each discharge cell C1 defined by the partition wall 15. The phosphor layers 16R, 16G and 16B are arranged in order in the row direction. A row of discharge cells C1 with the phosphor layers 16R, 16G and 16B arranged in the row direction forms each display line L.

The phosphor layers 16R, 16G and 16B are arranged such that the phosphor layers of the same color are not positioned in adjacent discharge cells Cl in the column direction (the vertical direction in FIG. 4). Specifically, in the example shown in FIG. 4, the phosphor layers of the same color are disposed diagonally toward the column on the left from each display line L to the lower display line L below it.

Consequently, in the example in FIG. 4, the red (R)-, green (G)- and blue (B)-colored phosphor layers 16R, 16G and 16B are also arranged in this order in the column direction.

In the PDP of the first embodiment, each pixel consists of the three discharge cells C1 arranged in line in the row direction as in the case of the conventional PDP. The pixels are arranged in matrix form over the panel surface in the row direction and the column direction. Because of the arrangement of the phosphor layers 16R, 16G and 16B as described above, the pixels G1, G2 and G3 are arranged in order from the top in the column direction in FIG. 4, and have the color orders shifted by one color in the row direction in the manner G1 (R, G, B), G2 (G, B, R) and G3 (B, R, G).

Adjacent phosphor layers 16R, 16G and 16B of different colors arranged in the column direction as described above are blocked from each other by the transverse walls 15B of the partition wall unit 15, to thereby prevent mixing of the colors of the adjacent phosphor layers in the column direction.

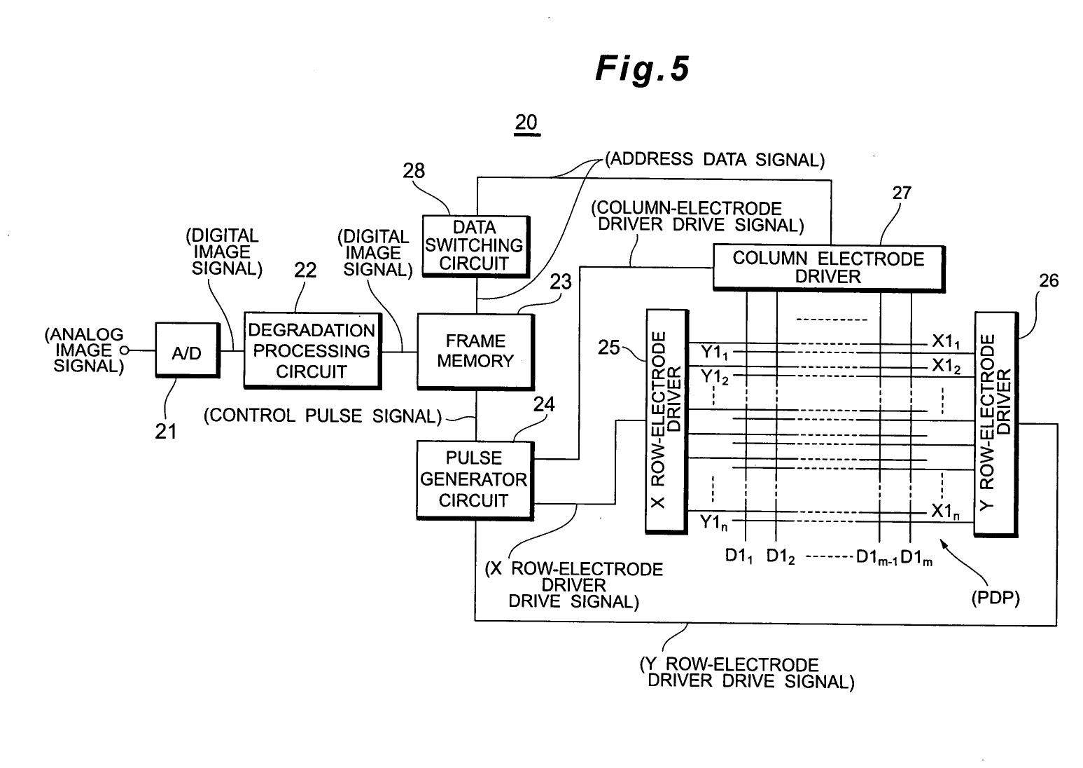

FIG. 5 is a block diagram of the drive unit of the PDP.

The drive unit 20 in FIG. 5 includes: an A/D converter circuit 21 performing A/D conversion processing on an input analog image signal; a gradation processing circuit 22 performing gradation processing on the digital image signal supplied from the A/D converter circuit 21 for conversion into digital data of a mode (e.g. 8 bits) corresponding to brightness gradation in each field in the subfield display; a frame memory circuit 23 receiving, from the gradation processing circuit 22, the digital image signal having undergone degradation processing; a pulse generator circuit 24 generating a control pulse signal for the frame memory circuit 23, a column-electrode driver drive signal, an X row-electrode driver drive signal, and a Y row-electrode driver drive signal; an X row-electrode driver 25 connected to each of the row electrodes X1 of the PDP; a Y row-electrode driver 26 connected to each of the row electrode Y1; a column-electrode driver 27 connected to each of the column electrodes D1; and further a data switching circuit 28 connected between the frame memory circuit 23 and the column-electrode driver 27.

Next, the method by which the drive unit controls the PDP will be described.

In FIG. 5, first, the A/D converter circuit 21 performs the A/D conversion processing on an input analog image signal to generate a digital image signal.

Then, the degradation processing circuit 22 performs predetermined degradation processing (e.g. the conversion processing to 8-bit digital data or the like) on the digital image signal supplied from the A/D converter circuit 21, and then supplies the result to the frame memory circuit 23.

The frame memory circuit 23 extracts address data from the digital image signal supplied from the gradation processing circuit 22 on the basis of a control pulse signal supplied from the pulse generator circuit 24, and sequentially reads and supplies the extracted address data to the data switching circuit 28.

The data switching circuit 28 switches, in a predetermined order, the address data signal supplied in synchronization with the control pulse signal from the frame memory circuit 23, and sends the result to the column electrode driver 27.

The switching operation for the address data signal in the data switching circuit 28 will be described later.

The column-electrode driver 27 receives a column-electrode driver drive signal outputted from the frame memory circuit 23. The column-electrode driver 27 selectively applies a data pulse to the column electrodes D1₁ to D1ₘ each connected to the column-electrode driver 27, on the basis of the column-electrode driver drive signal and the address data signal sent from the data switching circuit 28.

The X row-electrode driver 25 receives an X row-electrode driver drive signal outputted from the frame memory circuit 23. The X row-electrode driver 25 applies, in order, a discharge sustain pulse to the row electrodes X1₁ to X1ₙ each connected to the X row-electrode driver 25 on the basis of the X row-electrode driver drive signal.

The Y row-electrode driver 26 receives a Y row-electrode driver drive signal outputted from the frame memory circuit 23. The Y row-electrode driver 26 applies, in order, a scan pulse and a discharge sustain pulse to the row electrodes Y1₁ to Y1ₙ each connected to the Y row-electrode driver 26 on the basis of the Y row-electrode driver drive signal.

In each of the subfields into which the display period of a field is divided by the subfield method, in the address period for selecting the discharge cells C1 to produce a discharge after the simultaneous reset period, the Y row-electrode driver 26 is driven to apply in sequence the scan pulse to the row electrodes Y1₁ to Y1ₙ. The column-electrode driver 27 selectively applies the data pulse to the column electrodes D1₁ to D1ₘ. Thereupon, an address discharge is generated in the discharge cells C1 corresponding to the intersections of the row electrodes Y1₁ to Y1ₙ to which the scan pulse is applied and the column electrodes D1₁ to D1ₘ to which the data pulse is applied.

The address discharge results in the deposition of wall charges on the portions of the dielectric layer 11 facing the respective discharge cell C1 in which the address discharge is produced (or the erasure of the wall charge thereon).

Thus, the discharge cells C1 having the deposition of wall charge (light-emitting cells) and the discharge cells C1 in which the wall charge has been erased (non-light-emitting cells) are distributed over the panel surface in accordance with the address data signal of the image signal.

In the sustain discharge period following this, the X row-electrode driver 25 is driven to apply in order a discharge sustain pulse to the row electrodes X1₁ to X1ₙ, while the Y row-electrode driver 26 is also driven to apply in order a discharge sustain pulse to the row electrodes Y1₁ to Y1ₙ.

Thereby, a sustain light-emission discharge is produced between the paired row electrodes X1 and Y1 in the discharge cells C1 which are the light-emitting cells. By means of the sustain light-emission discharge, the phosphor layers 16R, 16G and 16B provided in the discharge cells C1 emit color light, thereby forming the image on the panel surface in accordance with the image signal.

In the drive operation of the PDP drive unit as described above, the data switching circuit 28 performs, in the address period of a subfield, the switching of the order of R, G and B described in the address data of the address data signal on the three adjacent display lines L differing in order of arrangement of the phosphor layers 16R, 16G and 16B from one another. This switching operation is performed as follows.

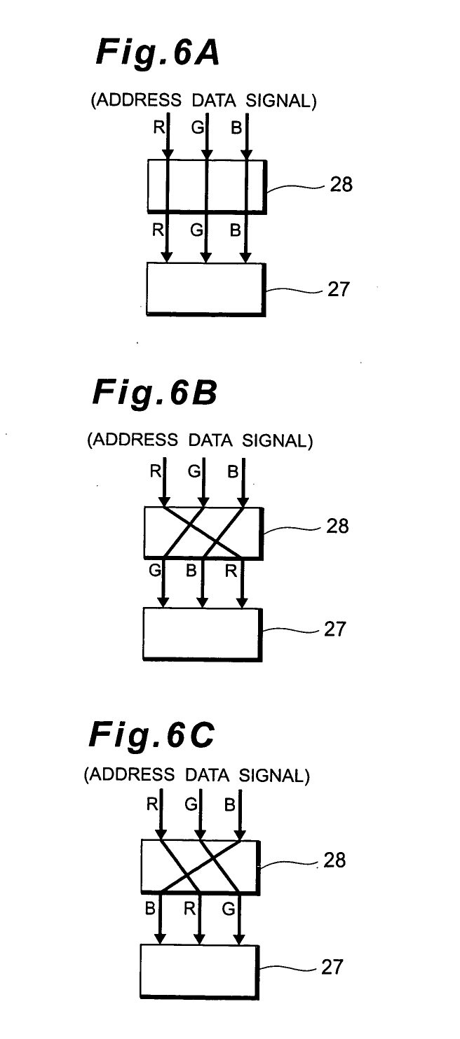

Regarding the address data signal for the first display line in which the pixels G1 with the color arrangement (R, G, B) of the phosphor layers are arranged, the data switching circuit 28 passes the address data to the column electrode driver 27 without making any change in the address data describing the order of colors, as shown in FIG. 6A.

Regarding the address data signal for the second display line in which the pixels G2 with the color arrangement (G, B, R) of the phosphor layers are arranged, the data switching circuit 28 switches the order R, G, B described in the address data of the address data signal to a order G, B, R in correspondence with the color arrangement of the phosphor layers in the pixel G2 as shown in FIG. 6B, and then applies the resulting signal to the column electrode driver 27.

Regarding the address data signal for the third display line in which the pixels G3 with the color arrangement (B, R, G) of the phosphor layers are arranged, the data switching circuit 28 switches the order R, G, B described in the address data of the address data signal to a order B, R, G in correspondence with the color arrangement of the phosphor layers in the pixel G3 as shown in FIG. 6C, and then applies the resulting signal to the column electrode driver 27.

In this manner, the PDP apparatus has the phosphor layers 16R, 16G and 16B formed in the discharge cells C1 arranged in matrix form in the row direction and the column direction such that the adjacent discharge cells C1 in the column direction differs from each other in the color of the phosphor layer. The data switching circuit 28 switches the order described in the address data of the address data signal for selecting the discharge cells C1 to allow for light emission to the order corresponding to the order of the phosphor layers 16R, 16G and 16B formed in the discharge cells C1 constituting a pixel. For example, when an image is displayed using a single-color raster signal, a conventional PDP emits light of the same color in a stripe pattern extending in the column direction. However, in the PDP according to the present invention, light of the same color is emitted from different points in adjacent display lines in the column direction.

The visual sensitivity of the human eye is lower in the oblique direction as compared with the visual sensitivities in the vertical direction and the horizontal direction. For this reason, the presence of the discharge cells C1 from which light is not emitted and which are arranged in the diagonal direction is made inconspicuous as compared with the case where the discharge cells C1 from which light is not emitted are arranged in the vertical direction. As a result, the PDP apparatus according to the embodiment is capable of displaying an image having a high spatial frequency enabling the viewers to perceive a picture with high definition.

In the foregoing PDP apparatus, what is required of the arrangement of the phosphor layers 16R, 16G and 16B in the discharge cells C1 is that discharge cells C1 of the same color should not be adjacent to each other in adjacent display lines L in the column direction. Therefore, the arrangement of the phosphor layers is not limited to the example described in FIG. 4. For example, the phosphor layers of the same color may be disposed diagonally towards the column to the right from each display line L to the lower display line L below it.

The foregoing has described the example of the data switching circuit 28 connected between the frame memory circuit 23 and the column electrode driver 27. However, the connection position of the data switching circuit 28 is not limited to this example, and may be any position as long as the data switching circuit 28 can switch the order described in the address data of the address data signal, such as between the degradation processing circuit 22 and the frame memory circuit 23, between the column electrode driver 27 and the column electrodes D1₁ to D1ₘ.

### Second Embodiment

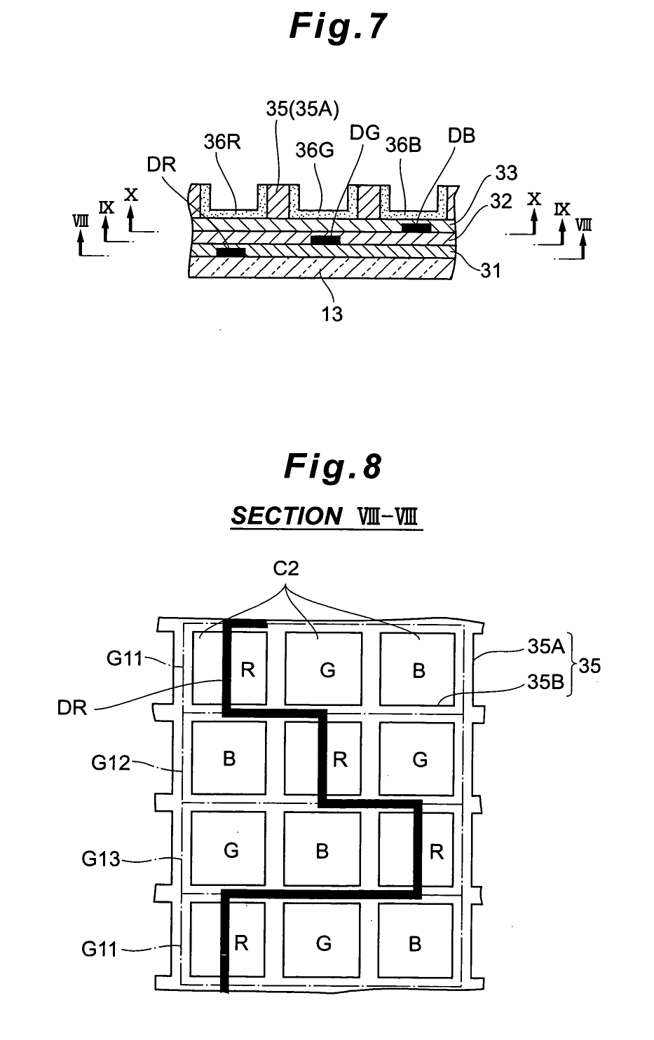

FIGS. 7 to 10 illustrate a second embodiment of a PDP apparatus according to the invention.

The structure of the front glass substrate and the components formed thereon (not shown) of the PDP apparatus in the second embodiment is the same as that of the first embodiment illustrated in FIG. 3.

In FIGS. 7 to 10, the PDP apparatus in the second embodiment has used-for-R column electrodes DR (hereinafter referred to as “R column electrodes DR”) formed on a back glass substrate 13 and covered by a first column-electrode protective layer 31. Used-for-G column electrodes DG (hereinafter referred to as “G column electrodes DG”) are formed on the first column-electrode protective layer 31 and covered by a second column-electrode protective layer 32. Used-for-B column electrodes DB (hereinafter referred to as “B column electrodes DB”) are formed on the second column-electrode protective layer 32 and covered by a third column-electrode protective layer 33.

The shapes of each R column electrode DR, each G column electrode DG and each B column electrode DB are described in detail later.

A substantially grid-shaped partition wall unit 35 having vertical walls 35A extending in the column direction and transverse walls 35B is formed on the third column-electrode protective layer 33. Red (R)-, green (G)- and blue (B)-colored phosphor layers 36R, 36G and 36B are formed in the discharge cells C2 defined in matrix by the partition wall unit 35 and arranged in order in the row direction.

The arrangement of the phosphor layer 36R, 36G and 35B differs that in the first embodiment. As shown in FIGS. 8 to 10, the phosphor layers of the same color are disposed diagonally toward the column on the right hand from each display line to the display line below it.

Each pixel consists of the three discharge cells C2 arranged in the row direction. The pixels are arranged in matrix form in the row direction and the column direction over the panel surface. The pixels G11, G12 and G13 are arranged in order from the top in the column direction, and have the color orders shifted by one color in the row direction in the manner G11 (R, G, B), G12 (B, R, G) and G13 (G, B, R).

Adjacent the phosphor layers 36R, 36G and 36B of different colors arranged in the column direction as described above are blocked from each other by the transverse walls 35B of the partition wall unit 35, to thereby prevent mixing of the colors of the adjacent phosphor layers in the column direction.

A set of three column electrodes, the R column electrode DR, the G column electrode DG and the B column electrode DB, is provided for a line of the pixels G11, G12, G13, G11, G12, G13 etc. arranged in the column direction.

The R column electrode DR is formed in a staggered shape to face the discharge cells C2 with the respective red phosphor layers 36R in the pixels G11, G12 and G13 arranged in line in the column direction.

More specifically, as shown in FIG. 8, the R column electrode DR first extends straight downward in the column direction in a position facing the discharge cell C2 with the red phosphor layer 36R positioned at the left end of the pixel G11. Then, the R column electrode DR extends toward the right in the row direction along the area facing the transverse wall 35B of the partition wall unit 35, and then extends straight downward in the column direction across the area facing the discharge cell C2 with the red phosphor layer 36R positioned in the center of the pixel G12. Following that, the R column electrode DR extends toward the right in the row direction along the area facing the transverse wall 35B of the partition wall unit 35, and then extends straight downward in the column direction across the area facing the discharge cell C2 with the red phosphor layer 36R positioned at the right end of the pixel G13. Next, the R column electrode DR extends toward the left in the row direction along the area facing the transverse wall 35B of the partition wall unit 35. In a repetition of the above process, the R column electrode DR is staggered from the pixel G11 below the last pixel G13 to face each of the discharge cells C2 in which the respective red phosphor layers 36R are formed.

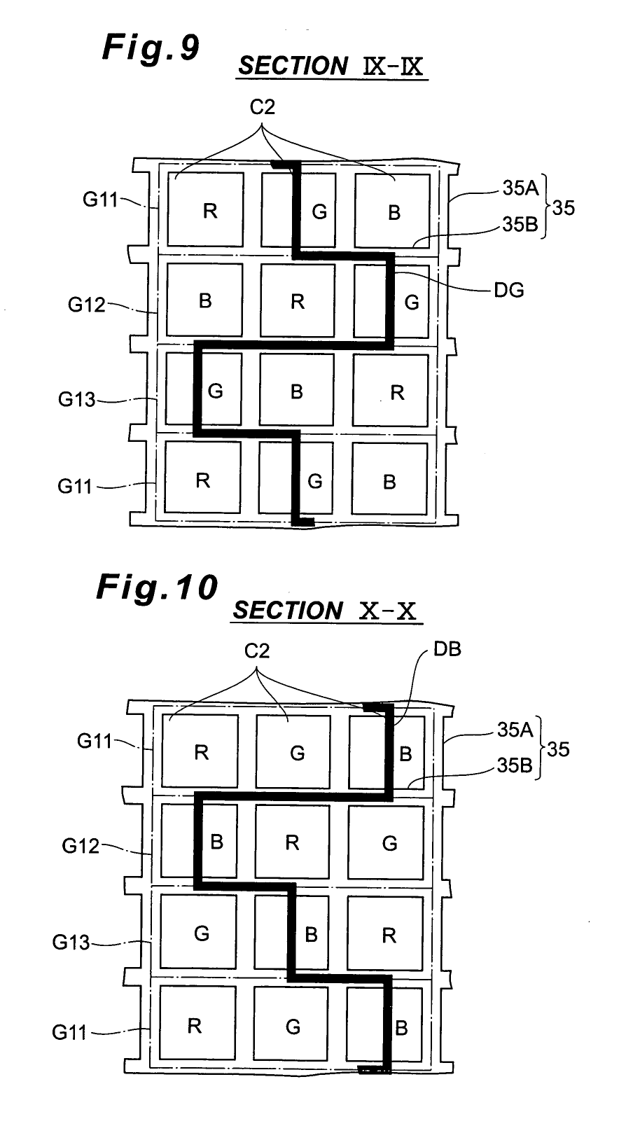

As in the case of the R column electrode DR, the G column electrode DG is formed in the staggered shape to face the discharge cells C2 with the respective green phosphor layers 36G in the pixels G11, G12 and G13 arranged in line in the column direction. More specifically, as shown in FIG. 9, the G column electrode DG is staggered along the areas facing transverse walls 35B of the partition wall unit 35 so as to face, in order, the discharge cell C2 with the green phosphor layer 36G positioned in the center of the pixel G11, the discharge cell C2 with the green phosphor layer 36G positioned at the right end of the pixel G12, and then the discharge cell C2 with the green phosphor layer 36G positioned at the left end of the pixel G13.

As in the case of the R column electrode DR, the B column electrode DB is formed in the staggered shape to face the discharge cells C2 with the respective blue phosphor layers 36B in the pixels G11, G12 and G13 arranged in line in the column direction. More specifically, as shown in FIG. 10, the B column electrode DB is staggered along the areas facing transverse walls 35B of the partition wall unit 35 so as to face, in order, the discharge cell C2 with the blue phosphor layer 36B positioned at the right end of the pixel G11, the discharge cell C2 with the blue phosphor layer 36B positioned at the left end of the pixel G12, and then the discharge cell C2 with the blue phosphor layer 36B positioned at the center of the pixel G13.

As in the case of the first embodiment, the PDP apparatus in the second embodiment produces an address discharge between the row electrodes formed on the front glass substrate by a data pulse based on the address data signal applied to the R column electrode DR, G column electrode DG and B column electrode DB, resulting in color light emission from each of the pixels G11, G12 and G13 in accordance with the address data.

As in the case of the first embodiment, the phosphor layers 36R, 36G and 36B are individually formed in the discharge cells C2 arranged in matrix form in the row direction and the column direction such that the adjacent discharge cells C2 in the column direction differs from each other in the color of the phosphor layer. Thereby, for example, when an image is displayed using a single-color raster signal, a conventional PDP emits light of the same color in a stripe pattern extending in the column direction. However, in the PDP according to the present invention, light of the same color is emitted from different points in adjacent display lines in the column direction.

The visual sensitivity of the human eye is lower in the diagonal direction as compared with the visual sensitivities in the vertical direction and the horizontal direction. For this reason, the presence of the discharge cells C2 from which light is not emitted and which are arranged in the diagonal direction is made inconspicuous as compared with the case where the discharge cells C2 form which light is not emitted are arranged in the vertical direction. As a result, it is possible for the PDP apparatus according to the embodiment to display an image having a high spatial frequency enabling the viewers to perceive a picture with high definition.

In the PDP apparatus of the second embodiment, the used-for-R column electrode DR, the used-for-G column electrode DG and the used-for-B column electrode DB are provided for each color of the phosphor layers 36R, 36G and 36B formed in the discharge cells C2. Accordingly, the PDP apparatus of the second embodiment has no need to provide a data switching circuit or the like for switching the address data signal in the drive unit of the PDP as provided in the first embodiment, thus simplifying the structure of the drive unit as compared with the PDP apparatus in the first embodiment.

In the foregoing PDP apparatus, what is required of the arrangement of the phosphor layers 36R, 36G and 36B in the discharge cells C2 is that the discharge cells C2 of the same color should not be adjacent to each other in adjacent display lines L in the column direction. Therefore, the arrangement of the phosphor layers is not limited to the example described in the second embodiment. For example, the phosphor layers of the same color may be disposed diagonally toward the column on the left from each display line L to the lower display line L below it.

Further, the order of forming the R column electrode DR, the G column electrode DG and the B column electrode DB is not limited to the examples described in the second embodiment, and they can be formed in an any given order.

The terms and description used herein are set forth by way of illustration only and are not meant as limitations. Those skilled in the art will recognize that numerous variations are possible within the spirit and scope of the invention as defined in the following claims.

1. A plasma display panel apparatus having unit light-emitting areas arranged in matrix form in a row direction and a column direction in a discharge space formed between a pair of parallel opposing substrates, comprising:
phosphor layers of three primary colors, red, green and blue, formed individually in the unit light-emitting areas,
wherein the three unit light-emitting areas, namely the unit light-emitting area having the red phosphor layer formed therein, the unit light-emitting area having the green phosphor layer formed therein and the unit light-emitting area having the blue phosphor layer formed therein, form a pixel,
wherein the phosphor layers of different colors are provided in adjacent unit light-emitting areas in the column direction,
wherein each of the pixels consists of the three adjacent unit light-emitting areas arranged in the row direction and respectively having the red phosphor layer, the green phosphor layer and the blue phosphor layer formed therein,
wherein the pixels are arranged in matrix form in the row direction and the column direction.

2. A plasma display panel apparatus according to claim 1, further comprising a partition wall unit that is formed substantially in a gird shape made up of vertical walls extending in the column direction and transverse walls extending in the row direction between the pair of substrates, and defines the unit light-emitting areas in which the red, green and blue phosphor layers are individually formed.

3. A plasma display panel apparatus according to claim 1, further comprising:
a plurality of row electrode pairs formed between the pair of substrates;
a plurality of column electrodes that are formed between the pair of substrates, each initiating an address discharge for selecting the unit light-emitting areas to emit light in conjunction with one row electrode in the row electrode pair, and each extending in the column direction to face the unit light-emitting areas in which the phosphor layers of different colors are formed;
an address data output member that outputs, to the column electrodes, address data for initiating an address discharge selectively between the column electrode and the row electrode; and
a data switching member that switches the address data supplied from the address data output members in correspondence with a order of the red, green and blue phosphor layers formed in the respective unit light-emitting areas in each of the pixels, and outputs the address data to the column electrodes.

4. A plasma display panel apparatus according to claim 1, further comprising:
a plurality of row electrode pairs formed between the pair of substrates;
a plurality of column electrodes that are formed between the pair of substrates, and each initiating an address discharge for selecting the unit light-emitting areas to emit light in conjunction with one row electrode in the row electrode pair, and which consist of used-for-red column electrodes each extending in the column direction and staggered to face only the unit light-emitting areas having the red phosphor layers formed therein, used-for-green column electrodes each extending in the column direction and staggered to face only the unit light-emitting areas having the green phosphor layers formed therein, and used-for-blue column electrodes each extending in the column direction and staggered to face only the unit light-emitting areas having the blue phosphor layers formed therein.

5. A plasma display panel apparatus according to claim 4, further comprising:
a partition wall unit that is formed between the pair of substrates and has at least transverse walls each extending in the row direction to block adjacent unit light-emitting areas in the column direction from each other,
wherein the used-for-red column electrode, the used-for-green column electrode and the used-for-blue column electrode are formed in a staggered shape by extending in the column direction in areas facing the phosphor layers formed in the respective unit light-emitting areas and extending in the row direction in areas facing the transverse walls of the partition wall unit.

6. A plasma display panel apparatus according to claim 4, wherein the used-for-red column electrode, the used-for-green column electrode and the used-for-blue column electrode are provided in a set form for each line of the pixels arranged in the column direction.

7. A plasma display panel apparatus according to claim 4, wherein the used-for-red column electrode, the used-for-green column electrode and the used-for-blue column electrode are formed on one substrate of the pair of substrates while being spaced from each other in the thickness direction of the substrate, and the used-for-red column electrode, the used-for-green column electrode and the used-for-blue column electrode are respectively covered by three protective layers.
